(19) United States
(12) Patent Application Publication
(10) Pub. No.: US 2009/0228428 A1
(43) Pub. Date: Sep. 10, 2009

(54) SOLUTION FOR AUGMENTING A MASTER DATA MODEL WITH RELEVANT DATA ELEMENTS EXTRACTED FROM UNSTRUCTURED DATA SOURCES

(75) Inventors: ASIT DAN, PLEASANTVILLE, NY (US); MAHESH VISWANATHAN, YORKTOWN HEIGHTS, NY (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/044,771

(22) Filed: Mar. 7, 2008

(51) Int. Cl. G06F 17/30

(52) U.S. Cl. 707/1; 707/E17.009

(57) ABSTRACT

The present invention discloses a method for augmenting a master data model with data elements extracted from unstructured data sources. Such a method can extract data elements related to the master data model of a master data management system from a set of unstructured data sources. The master data model can then be augmented to contain the extracted data elements. Data services for the master data model can then be enhanced to handle the extracted data elements.

### BACKGROUND OF THE INVENTION

The present invention relates to the field of data management and, more particularly, to augmenting a master data model with relevant data elements extracted from unstructured data sources.

Data management is a critical process for any business. Enterprise-level data systems often pay specific attention to key data elements called master data. Master data elements contain high-value business data that is used repeatedly across multiple business process and applications. Name, address, phone number, and date of birth are some common examples of master data associated with customer records.

Master data records are typically synthesized from specific, structured data sources, such as order forms, registration forms, accounting records, and such. These standard sources, while providing key information, capture static data. That is, a customer's name and address are not as fluid or dynamic as customer satisfaction or product enhancements.

Over time, businesses often receive a large quantity of data in unstructured formats that is relevant to master data entries. For example, email correspondence from customers often conveys the customer's level of satisfaction with a product and/or service. These relevant data elements are typically ignored because conventional master data models and management systems lack the capability to incorporate data from unstructured sources. This lack of capability results in a loss of critical information.

It is conventionally possible to perform an automated extraction of relevant information from unstructured data, such as through a structure (SQL based) query. Such extractions are often referred to as data mining. No known system data mines information from unstructured sources and places it in records of a database structured in accordance with a master data model. That is, conventional master data model based databases fail to leverage data mining techniques to record and track customer sentiments over time.

### BRIEF SUMMARY OF THE INVENTION

One aspect of the present invention can include a method for augmenting a master data model with data elements extracted from unstructured data sources. Such a method can extract data elements related to the master data model of a master data management system from a set of unstructured data sources. The master data model can then be augmented to contain the extracted data elements. Data services for the master data model can then be enhanced to handle the extracted data elements.

Another aspect of the present invention can include a system configured to augment a master data model with data elements extracted from unstructured data sources. Such a system can include a set of unstructured data sources, a data extraction tool, and a master data model augmenter. The set of unstructured data can contain information about a master data model. The data extraction tool can be configured to extract data elements from the set of unstructured data. The master data model augmenter can be configured to augment the master data model with the extracted data elements. Master data services can be added to read and update these enhanced master data models.

Yet another aspect of the present invention can include an enhanced master data model. The enhanced master data model can include data elements extracted from a set of unstructured data and a master data model. The master data model can be enhanced to include data fields in existing data tables to accommodate the extracted data elements.

### BRIEF DESCRIPTION OF THE SEVERAL VIEWS OF THE DRAWINGS

FIG. 1 is a hybrid schematic diagram illustrating a system and corresponding operations for augmenting a master data model with data elements extracted from unstructured data sources in accordance with embodiments of the inventive arrangements disclosed herein.

FIG. 2 is a flow chart of a method for augmenting a WEBSPHERE CUSTOMER CENTER and/or WEBSPHERE PRODUCT CENTER master data model with customer sentiment data elements extracted from unstructured data sources in accordance with an embodiment of the inventive arrangements disclosed herein.

FIG. 3 is a table illustrating a sample augmentation of a master data table in accordance with an embodiment of the inventive arrangements disclosed herein.

### DETAILED DESCRIPTION OF THE INVENTION

The present invention discloses a solution for enhancing a master data model with relevant data elements extracted from unstructured data sources. Master data models contain key data items that can span multiple data systems, such as customer and product data. Additional information pertinent to the contents of a master data model is often provided to a company in unstructured forms, such as emails, voice mail messages, and telephone conversations. The present invention can enhance an existing master data model to include pertinent data elements extracted from these unstructured data sources. The structured data extracted from the unstructured sources and placed in the master data model records can include customer-centric, product-centric, and/or service-centric data.

For example, the solution can augment the data model to track customers who own products or who use services and can determine and record their relative sentiments concerning those products or services. The solution can also augment product or service records to determine and record an overall product/service satisfaction level, product/service related defects, suggested product/service improvements, and the like.

As described herein, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

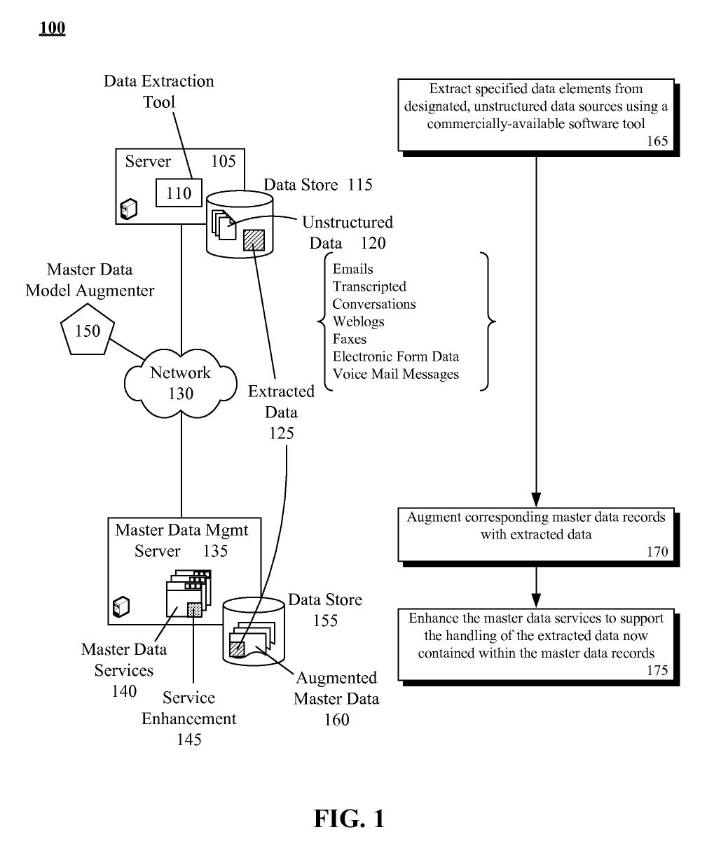

FIG. 1 is a hybrid schematic diagram illustrating a system 100 and corresponding operations for augmenting a master data model 160 with data elements 125 extracted from unstructured data sources 120 in accordance with embodiments of the inventive arrangements disclosed herein. In system 100, data elements 125 can be extracted from unstructured data sources 120 using a data extraction tool 110 and incorporated into a master data model 160.

As detailed in step 165, system 100 can extract specified data elements 125 from unstructured data sources 120 using a commercially-available software tool 110. A server 105 can include the data extraction tool 110 and the data store 115 containing the unstructured data 120. The data extraction tool 110 can correspond to the software tool described in step 165.

In an alternate embodiment, the data store 115 containing the unstructured data 120 can be located on a different server (not shown) that is accessible to the data extraction tool 110 over the network 130. In another configuration of the present invention, the unstructured data 120 can be contained in multiple data stores attached to separate servers that are all accessible to the data extraction tool 110 over the network 130.

The unstructured data 120 can represent a variety of electronic data that is received in formats that cannot be directly and/or contextually stored in a master data model. Examples of unstructured data sources can include, but are not limited to, emails, transcriptions of conversations, Weblogs, facsimiles, electronic form data, voice mail messages, and the like.

The extracted data 125 can be used in step 170 to augment corresponding master data records 160. The master data 160 can be located in the data store 155 of a master data management server 135. The master data management server 135 can be a commercially-available software application, such as WEBSPHERE CUSTOMER CENTER or WEBSPHERE PRODUCT CENTER that specifically manages master data 160 across enterprise-level applications.

The master data management server 135 can include multiple master data services 140 that handle requests for master data 160. These master data services 140 can be enhanced to support handling the augmented master data 160 as stated in step 175. Enhancement of the master data services 140 can be accomplished in variety of ways. As shown in this example, an existing master data service 140 can contain additional service enhancement code 145. Alternately, the service enhancement code 145 can exist as a separate service that can be called by an existing master data service 140.

Steps 170 and/or 175 can be performed by a master data model augmenter 150. The master data model augmenter 150 can represent the software, personnel, and/or processes required to augment the master data model 160. In this example, the master data model augmenter 150 can represent manually incorporating the extracted data 125 into the master data 160. In an alternate embodiment, the master data model augmenter 150 can be a software application running on the network 130 that automatically modifies the master data 160 and master data services 140 to handle the extracted data 125.

Interaction among the components of system 100 can be clarified through an example as follows. It should be appreciated that the following example is for illustrative purposes only and that the invention should not be construed as limited to the specific arrangements used within. In the example, Company A utilizes a master data management system 135 to handle customer information across all of its enterprise applications.

In the course of doing business, Company A captures a large amount of unstructured data 120 in the form of customer emails, feedback form submissions, and service reports. Many of these pieces of unstructured data 120 contain information relevant to the customer data contained within the master data 160. For example, emails and feedback form submissions from customers often express a customer's degree of satisfaction (or other sentiment) with a specific product and/or service. However, since this unstructured data 120 is primarily free-form text, additional processing is required in order to provide contextual coherency and the proper formatting for inclusion in the master data 160.

A data extraction tool 110 can utilize linguistic analysis and/or data mining tools to process emails and other free-form text items in order to determine a customer's satisfaction level (or other sentiment) with a specific product and/or service. Additional emails from the customer about the same product and/or service can be processed to track the customer's satisfaction level (or other sentiment) over time. The master data model augmenter 150 can expand the master data 160 tables to contain the extracted data 125 about the customer's satisfaction level (or other sentiment).

Further, the master data model augmenter 150 can modify master data services 140 to provide the customer satisfaction data to other enterprise applications. Additionally, the master data model augmenter 150 can create new master data services 140 that can be triggered by the extracted data 125. For example, whenever a customer's satisfaction level decreases below 95%, an email can be sent to inform the customer service department.

While the above example illustrates a customer-centric use of the system 100, the system 100 is designed to also operate in a produce-centric and/or service-centric fashion. In a product-centric example, unstructured data 120 can be analyzed in regards to a product or product line and product specific master data 160 records can be updated. The master data services 140 can be configured to take product specific actions based on changes to the product specific master data 160. For instance, if the changed data 160 indicates a product is popular, but typically out of stock, a service 140 can trigger execution of another business process or service designed to notify a manufacturer to increase product production and/or to notify a purchasing agent to increase a supply of the product.

To illustrate further, in system 100, a specific set of terms can be defined within the data extraction tool 110, which indicate a satisfaction or dissatisfaction with a product or service. For example, terms like “upset”, “request supervisor”, “unavailable”, “unhappy”, “irate”, “angry”, “mad”, “nice features”, “kudos”, “liked it”, “love it”, “money's worth”, “out-of-stock”, “late”, and the like can be contained in a series of customer communications, which are recorded as unstructured data 120 in data store 115. A computer algorithm, such as one for computing a Garbrand Quotient, can be used to derive a value from the unstructured data. Further analysis by tool 110 can associate terms with a specific product line, product, function or feature, customer, and the like. Similarly, the augmented master data 160 in data store 155 can include a set of RDBMS records for different product lines, products, functions or features, customers, services, etc. The derived data created by tool 110 can be placed as a value within an attribute files of suitable master data 160 records in an indexed and RDBMS query-able form. In one embodiment, a linkage can be maintained within the data store 155 between derived values and the unstructured data 120 (e.g., customer communications) from which values were derived.

As used herein, presented data stores, including stores 115 and 155, can be a physical or virtual storage space configured to store digital information. Data stores 115 and 155 can be physically implemented within any type of hardware including, but not limited to, a magnetic disk, an optical disk, a semiconductor memory, a digitally encoded plastic memory, a holographic memory, or any other recording medium. Each of the data stores 115 and 155 can be a stand-alone storage unit as well as a storage unit formed from a plurality of physical devices. Additionally, information can be stored within data stores 115 and/or 155 in a variety of manners. For example, information can be stored within a database structure or can be stored within one or more files of a file storage system, where each file may or may not be indexed for information searching purposes. Further, data stores 115 and/or 155 can utilize one or more encryption mechanisms to protect stored information from unauthorized access.

Network 130 can include any hardware, software, and/or firmware necessary to convey data encoded within carrier waves. Data can be contained within analog or digital signals and conveyed through data or voice channels. Network 130 can include local components and data pathways necessary for communications to be exchanged among computing device components and between integrated device components and peripheral devices. Network 130 can also include network equipment, such as routers, data lines, hubs, and intermediary servers which together form a data network, such as the Internet. Network 130 can also include circuit-based communication components and mobile communication components, such as telephony switches, modems, cellular communication towers, and the like. Network 130 can include line based and/or wireless communication pathways.

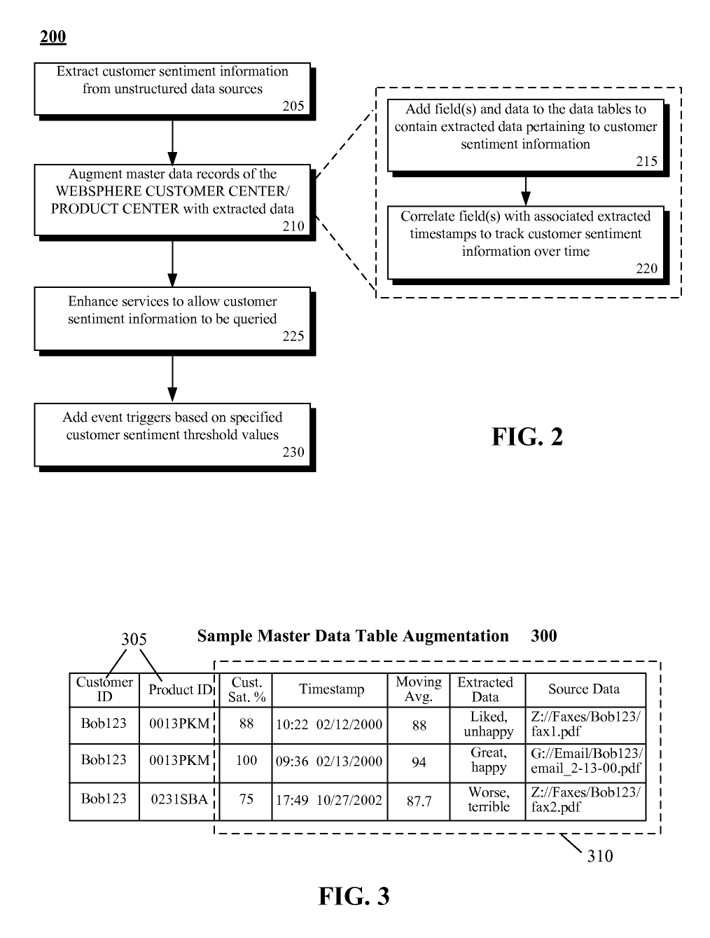

FIG. 2 is a flow chart of a method 200 for augmenting a WEBSPHERE CUSTOMER CENTER and/or WEBSPHERE PRODUCT CENTER master data model with customer sentiment data elements extracted from unstructured data sources in accordance with an embodiment of the inventive arrangements disclosed herein. Method 200 can be performed in the context of system 100 or any other system that augments a master data model with data elements extracted from unstructured data sources. In method 200, WEBSPHERE CUSTOMER CENTER and WEBSPHERE PRODUCT CENTER are used for illustrative purposes and is not to be considered a limitation of the invention and other master data management (MDM) systems can be utilized to a similar effect.

Method 200 can begin in step 205 where customer satisfaction level information can be extracted from unstructured data sources. In step 210, the master data records of the WEBSPHERE CUSTOMER CENTER and/or WEBSPHERE PRODUCT CENTER can be augmented with the data extracted in step 205.

Execution of step 210 can include steps 215 and 220. In step 215, fields and data can be added to the appropriate data tables to store the customer sentiment information. The fields added in step 215 can be correlated with their associated extracted timestamps in step 220 to allow the tracking of customer sentiment information over time.

In step 225, services can be enhanced to allow the customer sentiment information to be queried. Event triggers can be added in step 230 that are based upon customer satisfaction threshold values.

FIG. 3 is a table 300 illustrating a sample augmentation of a master data table in accordance with an embodiment of the inventive arrangements disclosed herein. Sample table 300 can be utilized within the context of system 100 and/or created by method 200. Although table 300 is shown in a customer-centric fashion, it should be realized that product-centric and service-centric master data table augmentations are also contemplated herein. It should be noted that the contents of table 300 are for illustrative purposes only and are not meant as a limitation or absolute implementation of the present invention.

Sample table 300 can represent the format of a master data table of a master data management system that has been augmented with data extracted from unstructured sources. Table 300 can include identifying data fields 305 and extracted data fields 310. In another embodiment, the extracted data fields 310 can be appended to a master data table containing existing data fields (not shown) obtained from structured sources.

The identifying fields 305 can represent one or more key values that contextually identify a record. In this example, records in table 300 are identified by a customer ID and a product ID.

The extracted data fields 310 can represent data fields created specifically to contain data extracted from unstructured sources. This example uses the concept of customer satisfaction to illustrate the extracted data fields 310. As such, extracted data fields 310 pertaining to customer satisfaction can include a customer satisfaction percentage, a timestamp for the data, a moving average or overall average, pertinent extracted data, and a pathway to the source of the extracted data.

Thus, the augmented master data table 300 can now convey a qualitative assessment of a customer's satisfaction level in general, by product, and/or by service based on unstructured, electronic correspondence. The master data table 300 can also be used for sentiments other than satisfaction, such as defects in products, problems with service, etc. Generally, any customer sentiment that changes over time and provides significant information about a customer, product, and/or service can be tracked using table 300 and associated table population and maintenance IT resources.

The flowchart and block diagrams in the FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for augmenting a master data model with data elements extracted from unstructured data sources comprising:
deriving at least one data element from a set of at least one unstructured data source, wherein each derived data element is related to a master data model of a master data management system;
augmenting the master data model to contain each derived data element; and
enhancing master data services to handle each derived data element contained in the master data model.

2. The method of claim 1, wherein one of the derived data elements comprises a customer sentiment, wherein said customer sentiment comprises a sentiment relating to at least one of a customer satisfaction in a product, a customer satisfaction in a service, a perceived defect with a product, a perceived problem with a service, a suggestion relating to a product, and a suggestion related to a service.

3. The method of claim 1, wherein the augmented master data model comprises a product master data model, which comprises a set of at least one product records, each associated with a specific product, wherein one of the derived data element comprises an attribute of the product records, wherein said attribute is a product quality attribute, and wherein the unstructured data sources from which the product quality attribute is determined comprise customer communications.

4. The method of claim 1, wherein the augmented master data model comprises a customer master data model, which comprises a set of at least one customer records, each associated with a specific customer, wherein one of the derived data element comprises an attribute of the customer records, wherein said attribute is a customer sentiment regarding a product or service, and wherein the unstructured data sources from which the customer sentiment attribute is determined comprise customer communications.

5. The method of claim 1, wherein the augmented master data model comprises a service master data model, which comprises a set of at least one service records, each associated with a specific service, wherein one of the derived data element comprises an attribute of the service records, wherein said attribute is a service quality attribute, and wherein the unstructured data sources from which the service quality attribute is determined comprise customer communications.

6. The method of claim 1, wherein the set of at least one unstructured data source comprises at least one customer communication, wherein said customer communication comprises at least one communication selected from a group of communications consisting of an email message, a weblog entry, a transcripted conversation, a facsimile document, electronic form data, and a voice mail message.

7. The method of claim 6, further comprising:
automatically linguistically analyzing the customer communication utilizing a previously defined set of rules, wherein said analyzing produces a sentiment score, wherein an element value for at least one of the derived data elements comprises said sentiment score.

8. The method of claim 6, wherein values of each of the derived data elements is tracked over time, wherein each of the tracked values is stored in a record of a data base.

9. The method of claim 8, wherein a continuously updated average value for each of the tracked values associated with derived data elements is calculated and stored in the master data model.

10. The method of claim 6, further comprising:
comparing a value of one of the derived data elements against a predetermined threshold value; and
selectively triggering an associated master data service depending upon results of comparing the value against the predetermined value.

11. The method of claim 10, further comprising:
updating a value of the derived at least one data element in accordance with a programmatic trigger, wherein said programmatic trigger performs said update based upon at least one of an occurrence of a scheduled periodic time, a receipt of an explicit user request, a receipt of an unstructured data source, and an occurrence of a programmatically determined condition exceeding a previously configured user established threshold for updating said value.

12. The method of claim 1, further comprising:
including a set of database records related to each of the derived data elements, maintaining a linkage between each derived data element record and each of the unstructured data sources of the set of unstructured data sources from which the data element is derived, wherein said linkage defines a path for accessing a stored version of the corresponding unstructured data source.

13. A computer program product for augmenting a master data model with data elements extracted from unstructured data sources, the computer program product comprising:
a computer usable medium having computer usable program code embodied therewith, the computer usable program code comprising:
computer usable program code configured to derive at least one data element from a set of at least one unstructured data source, wherein each derived data element is related to a master data model of a master data management system;
computer usable program code configured to augment master data model to contain each derived data element; and
computer usable program code configured to enhance master data services to handle each derived data element contained in the master data model, wherein one of the derived data elements comprises a customer sentiment, wherein said customer sentiment comprises a sentiment relating to at least one of a customer satisfaction in a product, a customer satisfaction in a service, a perceived defect with a product, a perceived problem with a service, a suggestion relating to a product, and a suggestion related to a service, wherein the set of at least one unstructured data source comprises at least one customer communication, and wherein said customer communication comprises at least one communication selected from a group of communications consisting of an email message, a weblog entry, a transcripted conversation, a facsimile document, electronic form data, and a voice mail message.

14. A system for augmenting a master data model with data elements extracted from unstructured data sources comprising:
a data store comprising a set of at least one unstructured electronic document, wherein each electronic document represents a customer communication;
a data extraction tool configured to derive values for at least one user-defined data element from the set of unstructured electronic documents given a set of one or more configurable programmatic rules; and
a master data model augmenter configured to augment relational database records of a master data management system comprising attributes for each of the user-defined data elements with said derived values from the data extraction tool, wherein master data management system conforms to a master data model.

15. The system of claim 14, wherein said customer communications comprises at least one communication selected from a group of communications consisting of an email message, a weblog entry, a transcripted conversation, a facsimile document, electronic form data, and a voice mail message.

16. The system of claim 14, wherein the augmented master data model comprises a product master data model, which comprises a set of at least one product records, each associated with a specific product, wherein one of the derived data element comprises an attribute of the product records, and wherein said attribute is a product quality attribute.

17. The system of claim 14, wherein the augmented master data model comprises a customer master data model, which comprises a set of at least one customer records, each associated with a specific customer, wherein one of the derived data element comprises an attribute of the customer records, wherein said attribute is a customer sentiment regarding a product or service.

18. The system of claim 14, wherein the augmented master data model comprises a service master data model, which comprises a set of at least one service records, each associated with a specific service, wherein one of the derived data element comprises an attribute of the service records, wherein said attribute is a service quality attribute.

19. The system of claim 13, wherein the master data record system comprises at least one data service that is configured to be triggered based upon a change in at least one of the derived values.

20. The system of claim 14, wherein said master data management system comprises a plurality of records linked to each derived value, wherein said plurality of records comprise a path attribute of a source electronic document, wherein a value in said path attribute defines a path for accessing a stored version of the corresponding unstructured data source.
